(19) United States
(12) Patent Application Publication
(10) Pub. No.: US 2012/0243402 A1
(43) Pub. Date: Sep. 27, 2012

(54) MOBILE TERMINAL APPARATUS, RADIO BASE STATION APPARATUS, AND RADIO COMMUNICATION METHOD

(75) Inventors: Yoshihisa Kishiyama, Tokyo (JP); Teruo Kawamura, Tokyo (JP); Motohiro Tanno, Tokyo (JP)

(73) Assignee: NTT DOCOMO, INC., Tokyo (JP)

(21) Appl. No.: 13/504,136

(22) PCT Filed: Nov. 2, 2010
(86) PCT No.: PCT/JP2010/069484

§ 371 Date: Jun. 13, 2012

(30) Foreign Application Priority Data
Nov. 2, 2009 (JP) 2009-252367

(51) Int. Cl. H04W 72/04; H04L 29/14

(52) U.S. Cl. 370/216

(57) ABSTRACT

To provide a mobile terminal apparatus, radio base station apparatus and radio communication method for enabling data signals and control information for a plurality of component carriers to be transmitted efficiently, a radio communication method of the invention is characterized in that a mobile terminal apparatus maps a retransmission response signal and another signal to different resources in a first mode for transmitting a retransmission response signal for each downlink CC of a plurality of downlink CCs, while mapping the retransmission response signal and another signal to the same resources in a second mode for transmitting a single retransmission response signal for a plurality of downlink CCs, and that the radio base station apparatus receives the uplink signal, preforms resource-demapping on each of the retransmission response signal and another signal mapped to different resources in the first mode, while performing resource-demapping on the retransmission response signal and another signal mapped to the same resources in the second mode, and demodulates the retransmission response signal.

### TECHNICAL FIELD

The present invention relates to a mobile terminal apparatus, radio base station apparatus, and radio communication method.

### BACKGROUND ART

In UMTS (Universal Mobile Telecommunications System) networks, for the purpose of improving spectral efficiency and further improving data rates, by adopting HSDPA (High Speed Downlink Packet Access) and HSUPA (High Speed Uplink Packet Access), it is performed exploiting maximum features of the system based on W-CDMA (Wideband Code Division Multiple Access). For the UMTS network, for the purpose of further increasing high-speed data rates, providing low delay and the like, Long Term Evolution (LTE) has been studied (Non-patent Document 1). In LTE, as a multiplexing scheme, OFDM (Orthogonal Frequency Division Multiple Access) different from W-CDMA is used in downlink, and SC-FDMA (Single Carrier Frequency Division Multiple Access) is used in uplink.

An uplink signal transmitted in uplink is transmitted from a mobile terminal apparatus to a radio base station apparatus as shown in FIG. 1. User data (UE (User Equipment) #1, UE#2) is assigned to the Physical Uplink Shared Channel (PUSCH), and control information is time-multiplexed with the PUSCH when the control information is transmitted concurrently with the user data, while being assigned to the Physical Uplink Control Channel (PUCCH) when only the control information is transmitted. On the Physical Uplink Control Channel, downlink quality information (CQI: Channel Quality Indicator), retransmission response (ACK/NACK) of the downlink shared channel, and so forth are transmitted.

On the PUCCH, different subframe configurations are adopted between the CQI and ACK/NACK (FIG. 2). In the subframe configuration as shown in FIG. 2, one slot (½ subframe) contains 7 SC-FDMA symbols. Further, one SC-FDMA symbol contains 12 information symbols (subcarriers) . More specifically, in the CQI subframe configuration (CQI format) , as shown in FIG. 2 (a), a reference signal (RS) is multiplexed into the 2nd symbol (#2) and 6th symbol (#6) in a slot, and control information (CQI) is multiplexed into the other symbols (1st symbol, 3rd to 5th symbols, 7th symbol). Meanwhile, in the ACK/NACK subframe configuration (ACK/NACK format), as shown in FIG. 2 (b), a reference signal (RS) is multiplexed into the 3rd (#3) to 5th (#5) symbols in a slot, and control information (ACK/NACK) is multiplexed into the other symbols (1st symbol (#1), 2nd symbol (#2), 6th symbol (#6), 7th symbol (#7)).

### CITATION LIST

### Non-patent Literature

Non-patent Literature 1: 3GPP, TR25.912 (V7.1.0) “Feasibility study for Evolved UTRA and UTRAN”, Sept. 2006

### SUMMARY OF THE INVENTION

### Technical Problem

In the 3G system, a fixed band of 5 MHz is substantially used, and it is possible to achieve transmission rates of approximately maximum 2 Mbps in downlink. Meanwhile, in the LTE system, using variable bands ranging from 1.4 MHz to 20 MHz, it is possible to achieve transmission rates of maximum 300 Mbps in downlink and about 75 Mbps in uplink. Further, in the UMTS network, for the purpose of further increasing the wide-band and high speed, successor systems to LTE have been studied (for example, LTE Advanced (LTE-A)).

In LTE-A systems, for the purpose of further improving spectral efficiency, peak throughput, etc., assignments of frequencies with a wider band than in LTE are studied. Further, in LTE-A systems, having backward compatibility with LTE is one of requirements, and therefore, the LTE-A system adopts the configuration of a transmission band with a plurality of base frequency blocks (component carriers (CCs)), each having a bandwidth usable in LTE, arranged. Therefore, the feedback control information for data channels transmitted on a plurality of downlink CCs increases by times corresponding to the number of CCs. Further, in addition to the feedback control information of LTE such as ACK/NACK, CQI, and PMI (Precoding Matrix Indicator), increases are considered in feedback control information dedicated to LTE-A for Multi-cell Coordinated transmission/reception techniques, higher order MIMO, etc. Therefore, it is necessary to study a transmission method of control information for a plurality of component carriers.

The present invention was made in view of such a respect, and it is an object of the invention to provide a mobile terminal apparatus, radio base station apparatus and radio communication method for enabling data signals and control information for a plurality of component carriers to be transmitted efficiently.

### Solution to Problem

A mobile terminal apparatus of the invention is characterized by having retransmission response signal generating means for generating a retransmission response signal, and resource mapping means for mapping the retransmission response signal and another signal to different resources in a first mode for transmitting a retransmission response signal for each downlink component carrier of a plurality of downlink component carriers, while mapping the retransmission response signal and another signal to the same resources in a second mode for transmitting a single retransmission response signal for a plurality of downlink component carriers.

A radio base station apparatus of the invention is characterized by having receiving means for receiving an uplink signal including a retransmission response signal and another signal, resource demapping means for preforming resource-demapping of each of the retransmission response signal and the another signal mapped to different resources in a first mode for transmitting a retransmission response signal for each downlink component carrier of a plurality of downlink component carriers, while performing resource-demapping of the retransmission response signal and the another signal mapped to the same resources in a second mode for transmitting a single retransmission response signal for a plurality of downlink component carriers, and demodulation means for demodulating the retransmission response signal.

A radio communication method of the invention is characterized by having the steps in a mobile terminal apparatus of generating a retransmission response signal, of mapping the retransmission response signal and another signal to different resources in a first mode for transmitting a retransmission response signal for each downlink component carrier of a plurality of downlink component carriers, while mapping the retransmission response signal and another signal to the same resources in a second mode for transmitting a single retransmission response signal for a plurality of downlink component carriers, and of transmitting an uplink signal including the retransmission response signal and the another signal to a radio base station apparatus, and the steps in the radio base station apparatus of receiving the uplink signal, of performing resource-demapping of each of the retransmission response signal and the another signal mapped to different resources in the first mode, while performing resource-demapping of the retransmission response signal and the another signal mapped to the same resources in the second mode, and of demodulating the retransmission response signal.

### Technical Advantage of the Invention

In the invention, according to a transmission form (first mode, second mode) of a retransmission response signal, the retransmission response signal and another signal are mapped to different resources, or the retransmission response signal and another signal are mapped to the same resources, and it is thereby possible to efficiently transmit data signals and control information for a plurality of component carriers.

### BRIEF DESCRIPTION OF DRAWINGS

FIG. 1 is a diagram to explain a configuration of an uplink signal;

FIGS. 2(a) and 2(b) are diagrams illustrating subframe configurations of uplink control channel signals;

FIG. 3 is a diagram illustrating a transmission method of uplink retransmission response signals to a plurality of downlink component carriers;

FIG. 4 is a diagram illustrating another transmission method of uplink retransmission response signals to a plurality of downlink component carriers;

FIGS. 5(a) and 5(b) are diagrams illustrating a transmission method of uplink retransmission response signals to a plurality of downlink component carriers according to the invention;

FIG. 6 is a diagram illustrating another transmission method of uplink retransmission response signals to a plurality of downlink component carriers according to the invention;

FIG. 7 is a diagram illustrating a radio communication system having radio base station apparatuses and mobile terminal apparatuses according to an Embodiment of the invention;

FIG. 8 is a diagram illustrating a schematic configuration of the mobile terminal apparatus according to the Embodiment of the invention;

FIG. 9 is a functional block diagram of a baseband signal processing section of the mobile terminal apparatus as shown in FIG. 8;

FIG. 10 is a diagram illustrating a schematic configuration of the radio base station apparatus according to the Embodiment of the invention; and

FIG. 11 is a functional block diagram of a baseband signal processing section of the radio base station apparatus as shown in FIG. 10.

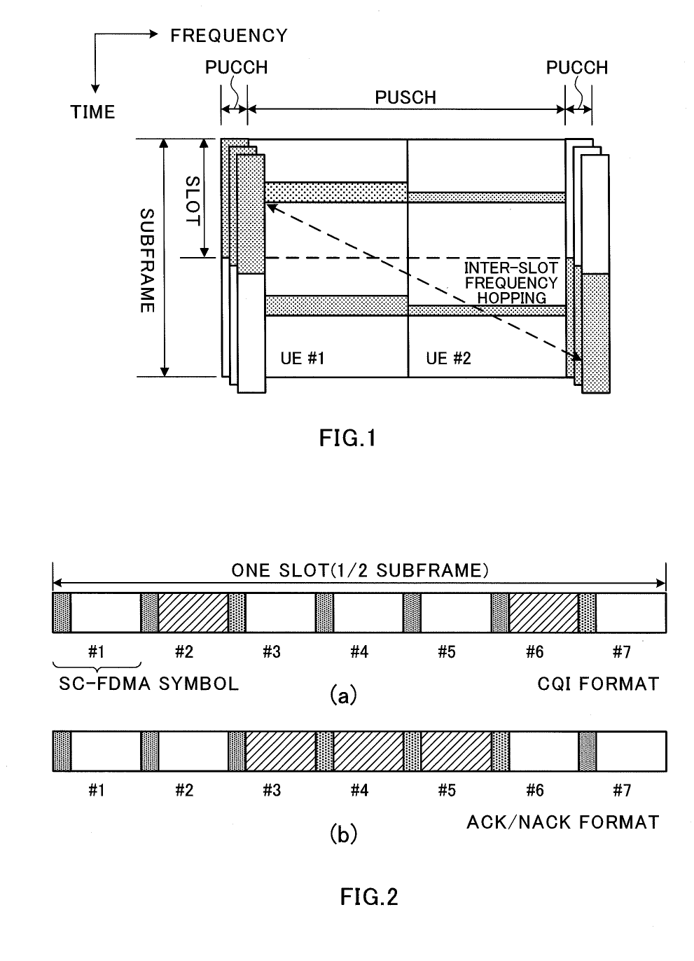

### DESCRIPTION OF EMBODIMENTS

An Embodiment of the invention will specifically be described below with reference to accompanying drawings.

For a signal of the Physical Downlink Shared Channel (PDSCH) of a downlink CC, a retransmission response signal (ACK/NACK) that is feedback control information for the signal is transmitted on the PUCCH. The content of a retransmission response signal (ACK/NACK) is expressed by either an acknowledgment response (ACK:Acknowledgment) indicating that the transmission signal is correctly received or a negative acknowledgment response (NACK:Negative Acknowledgment) indicating that the transmission signal is not correctly received.

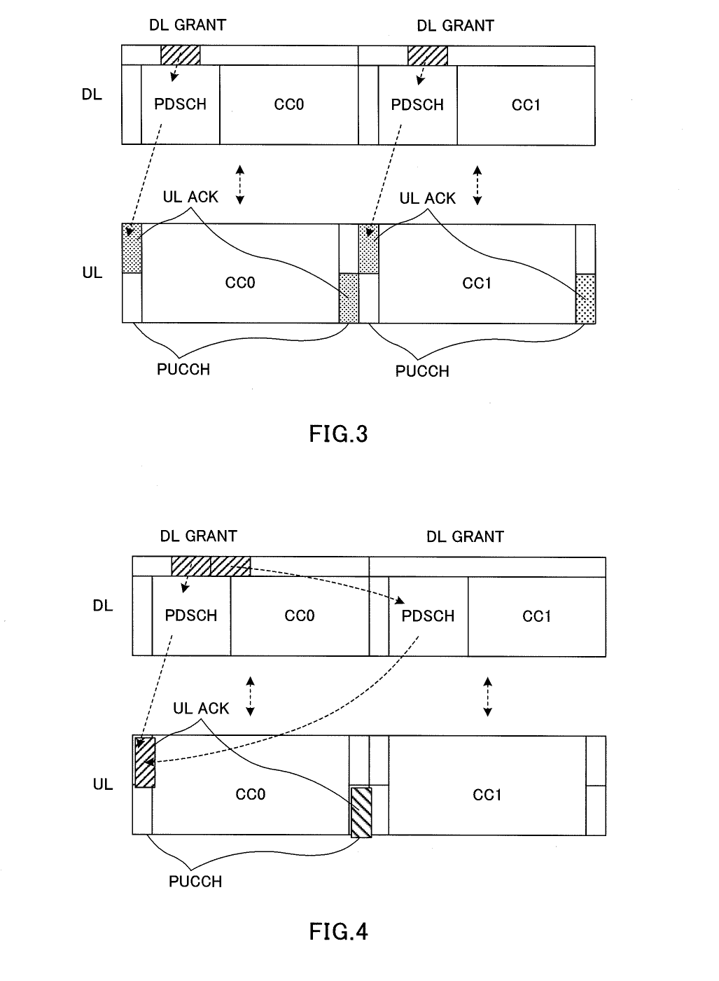

FIGS. 3 and 4 are diagrams illustrating transmission methods of uplink retransmission response signals for a plurality of downlink CCs. Retransmission response signals (ACK/NACK) that are feedback control information for PDSCHs transmitted in a plurality of downlink CCs are transmitted as shown in FIGS. 3 and 4. In other words, a radio base station apparatus assigns downlink resource blocks using downlink scheduling information (DL Scheduling Information: DL grant) included in the Physical Downlink Control Channel (PDCCH). Then, a PDSCH signal is transmitted from the radio base station apparatus to a mobile terminal apparatus. The mobile terminal apparatus determines whether there is an error in the received PDSCH signal, and transmits the determination result to the radio base station apparatus on the PUCCH as a retransmission response signal (ACK/NACK).

As described above, in LTE-A systems, for the purpose of further improving spectral efficiency, peak throughput, etc., assignments of frequencies with a wider band than in LTE are studied, and the LTE-A system adopts the configuration of a transmission band with a plurality of base frequency blocks (component carriers (CCs)) , each having a bandwidth usable in LTE, arranged. Therefore, it is conceivable that retransmission response signals that are the feedback control information for PDSCHs transmitted in a plurality of downlink CCs are transmitted to a plurality of downlink CCs.

In this case, as a first transmission method, as shown in FIG. 3, there is a method (mode A) of transmitting each retransmission response signal on the PUCCH of an uplink component carrier that is a paired band. In other words, in the first transmission method, as shown in FIG. 3, a retransmission response signal (UL ACK) for a downlink CC0 is transmitted on the PUCCH of an uplink CC0 that is a paired band of the downlink CC0, and a retransmission response signal (UL ACK) for a downlink CC1 is transmitted on the PUCCH of an uplink CC1 that is a paired band of the downlink CC1. Thus, in the first transmission method, a plurality of retransmission response signals are transmitted parallel with different resources (multicarrier/multi-resource). In addition, in the first transmission method, resource blocks of the PDSCH are allocated based on a DL grant of the PDCCH of each CC. In other words, resource blocks of the PDSCH of the downlink CC0 are allocated based on a DL grant of the PDCCH of the downlink CC0, and resource blocks of the PDSCH of the downlink CC1 are allocated based on a DL grant of the PDCCH of the downlink CC1.

Meanwhile, as a second transmission method, as shown in FIG. 4, there is a method (mode B) of transmitting a single retransmission response signal on the PUCCH of one uplink component carrier (a method of transmitting single ACK when retransmission response signals to all CCs are ACK). In other words, in the second transmission method, as shown in FIG. 4, a single retransmission response signal (UL ACK) for the downlink CC0 and downlink CC1 is transmitted on the PUCCH of the uplink CC0 that is a paired band of the downlink CC0. Thus, in the second transmission method, retransmission response signals for a plurality of downlink CCs are transmitted as a single retransmission response signal. In addition, in the second transmission method, resource blocks of the PDSCH are allocated based on each DL grant in the PDCCH of one CC. In other words, resource blocks of the PDSCH of the downlink CC0 are allocated based on a DL grant for the downlink CC0 of the PDCCH of the downlink CC0, and resource blocks of the PDSCH of the downlink CC1 are allocated based on a DL grant for the downlink CC1 of the PDCCH of the downlink CC0.

In addition, in FIGS. 3 and 4, the case is described where the number of downlink CCs is “2”, the number of uplink CCs is “2”, and UL ACK is transmitted in the uplink CC0 in the second transmission method, but the invention is not limited thereto, and the number of downlink CCs, the number of uplink CCs, and an uplink CC to transmit UL ACK in the second transmission method are capable of being changed as appropriate.

As described above, in the LTE-A system, it is necessary to efficiently transmit the feedback control information for a plurality of CCs. Accordingly, in the transmission methods of retransmission response signals as described above, it is required to efficiently transmit other signals, for example, a Physical Uplink Shared Channel (PUSCH) signal, and uplink control information (CQI, PMI, scheduling request, etc.) except the retransmission response signal.

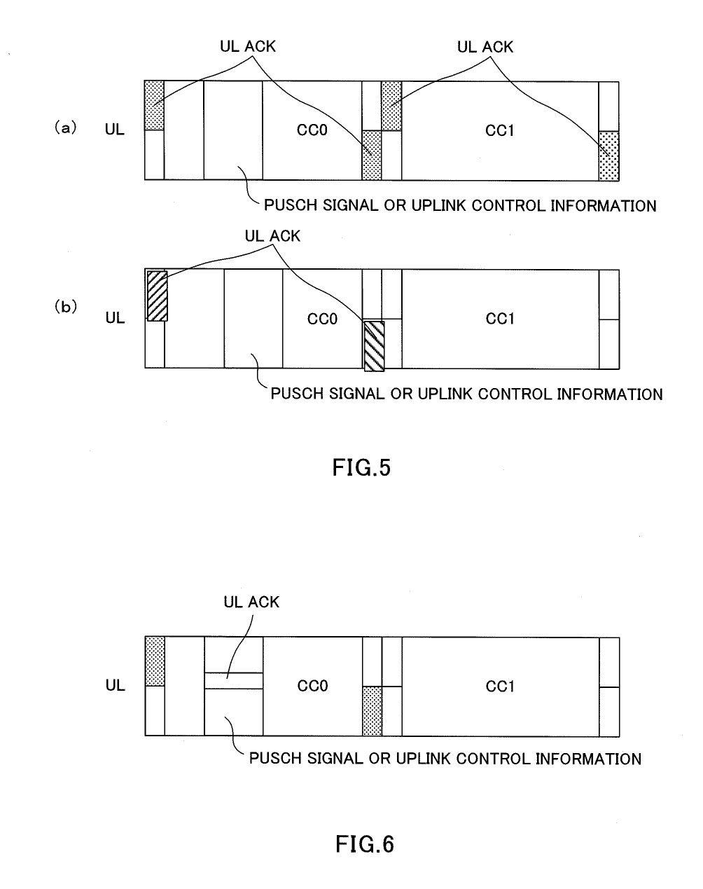

Therefore, the inventors of the invention propose changing the multiplexing scheme of other signals between the first transmission method and the second transmission method for transmitting retransmission response signals. In other words, in the first transmission method (mode A), the retransmission response signal and other signals are mapped to different resources. In other words, in the first transmission method (mode A), the retransmission response signal, and a PUSCH signal and/or other uplink control information are transmitted parallel with different resources (multi-resource/multicarrier). In this case, Frequency Division Multiplexing (FDM) may be performed as shown in FIG. 5 (a), or Code Division Multiplexing (CDM) may be performed as shown in FIG. 5 (b).

In addition, in the case of performing Code Division Multiplexing, a code used in the retransmission response signal is set by a resource index of the downlink scheduling information, and for codes used in the PUSCH signal and other uplink control information, beforehand determined code numbers are notified by Higher layer signaling.

In the second transmission method (mode B), the retransmission response signal and other signals are mapped to different resources. In other words, in the first transmission method (mode A), the retransmission response signal, and a PUSCH signal and/or other uplink control information are transmitted in a serial manner with the same resources. In other words, the retransmission response signal is transmitted using resources used in the PUSCH signal or other uplink control information. In this case, as shown in FIG. 6, Time Division Multiplexing is used.

Thus, in the present invention, the method for multiplexing the retransmission response signal and the PUSCH signal and/or other uplink control information is switched, according to the transmission mode of the retransmission response signal as described above. In other words, the mobile terminal apparatus maps the retransmission response signal and another signal to different resources in the first mode for transmitting a retransmission response signal for each downlink CC of a plurality of downlink CCs, or maps the retransmission response signal and another signal to the same resources in the second mode for transmitting a single retransmission response signal for a plurality of downlink CCs, and the radio base station apparatus preforms resource-demapping of each of the retransmission response signal and the another signal mapped to different resources in the first mode, or performs resource-demapping of the retransmission response signal and the another signal mapped to the same resources in the second mode, and demodulates the retransmission response signal. Thus, according to the transmission form of the retransmission response signal, the retransmission response signal and another signal are mapped to different resources, or the retransmission response signal and another signal are mapped to the same resources, and it is thereby possible to efficiently transmit control information for a plurality of CCs.

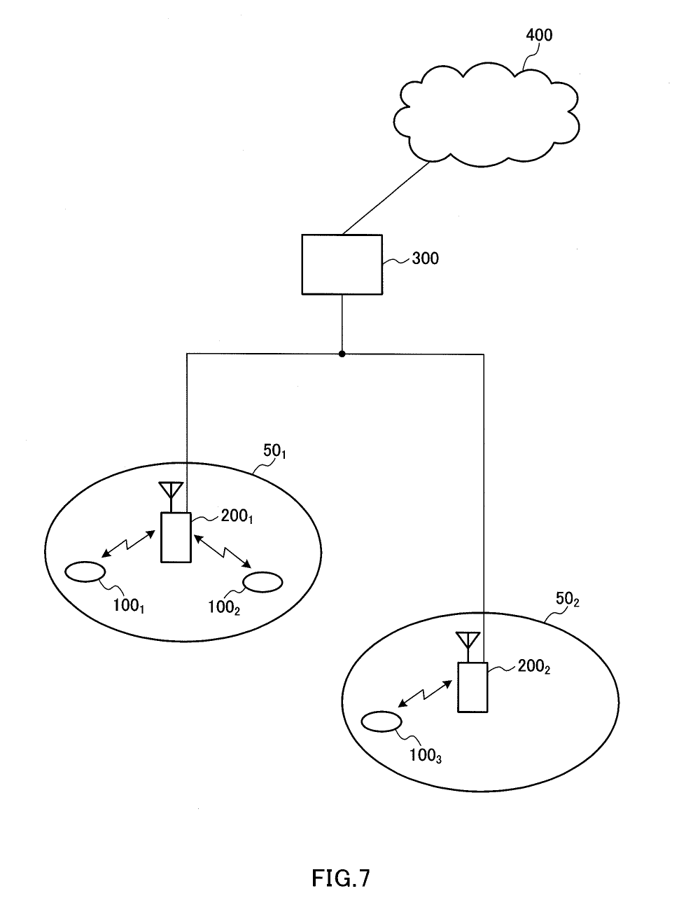

FIG. 7 is a diagram illustrating a radio communication system having mobile terminal apparatuses and radio base station apparatuses according to the Embodiment of the invention.

The radio communication system is a system to which, for example, E-UTRA (Evolved UTRA and UTRAN) is applied. The radio communication system is provided with radio base station apparatuses (eNB: eNodeB) 200 (200₁, 200₂, 200₃, . . . ,200₁, I is an integer where I>0) and a plurality of mobile terminal apparatuses (UE) 100ₙ (100₁, 100₂, 100₃, . . . ,100ₙ, n is an integer where n>0) that communicate with the radio base station apparatuses 200. The radio base station apparatus 200 is connected to an upper station, for example, an access gateway apparatus 300, and the access gateway apparatus 300 is connected to a core network 400. The mobile terminal apparatus 100ₙ communicates with the radio base station apparatus 200 in a cell 50 (50₁, 50₂) by E-UTRA. This Embodiment shows two cells, but the invention is similarly applied to three cells or more. In addition, each of the mobile terminal apparatuses (100₁, 100₂, 100₃, . . . , 100ₙ) has the same configuration, function and state, and is described as a mobile terminal apparatus 100ₙ unless otherwise specified in the following description.

In the radio communication system, as a radio access scheme, OFDM (Orthogonal Frequency Division Multiplexing) is applied in downlink, while SC-FDMA (Single-Carrier Frequency Division Multiple Access) is applied in uplink. OFDM is a multicarrier transmission scheme for dividing a frequency band into a plurality of narrow frequency bands (subcarriers), and mapping data to each subcarrier to perform communications. SC- FDMA is a single-carrier transmission scheme for dividing a frequency band for each terminal so that a plurality of terminals uses mutually different frequency bands, and thereby reducing interference among the terminals.

Described herein are communication channels in E-UTRA.

In downlink, used are the Physical Downlink Shared Channel shared among the mobile terminal apparatuses 100ₙ, and the Physical Downlink Control Channel. The Physical Downlink Control Channel is also called the downlink L1/L2 control channel. User data i.e. normal data signals are transmitted on the Physical Downlink Shared Channel. Meanwhile, on the Physical Downlink Control Channel, downlink scheduling information, retransmission response signal (ACK/NACK), uplink scheduling grant (UL Scheduling Grant), TPC command (Transmission Power Control Command), and so forth are transmitted. For example, the downlink scheduling information includes an ID of a user to perform communications using the Physical Downlink Shared Channel, information of a transport format of the user data, i.e. information on the data size, modulation scheme, and retransmission control (HARQ:Hybrid ARQ), downlink resource block assignment information, etc.

Meanwhile, for example, the uplink scheduling grant includes an ID of a user to perform communications using the Physical Uplink Shared Channel, information of a transport format of the user data, i.e. information on the data size and modulation scheme, uplink resource block assignment information, information on transmission power of the Physical Uplink Shared Channel, etc. Herein, the uplink resource block corresponds to frequency resources, and is also called the resource unit.

In uplink, used are the Physical Uplink Shared Channel shared among the mobile terminal apparatuses 100ₙ, and the Physical Uplink Control Channel. User data i.e. normal data signals are transmitted on the Physical Uplink Shared Channel. Meanwhile, on the Physical Uplink Control Channel is transmitted downlink quality information used in scheduling processing of the shared channel in downlink and adaptive modulation/demodulation and coding processing, and the retransmission response signal of the Physical Downlink Shared Channel.

On the Physical Uplink Control Channel, a scheduling request to request resource allocation of the uplink shared channel, release request in persistent scheduling and the like may be transmitted, in addition to the CQI and retransmission response signal. Herein, resource allocation of the uplink shared channel means that a radio base station apparatus notifies a mobile terminal apparatus that the mobile terminal apparatus is allowed to perform communications using the uplink shared channel in a subsequent subframe, using the downlink control channel in some subframe.

The mobile terminal apparatus 100ₙ communicates with an optimal radio base station apparatus. In the example as shown in FIG. 7, mobile terminal apparatuses 100₁ and 100₂ communicate with a radio base station apparatus 200₁, and a mobile terminal apparatus 100₃ communicates with a radio base station apparatus 200₂.

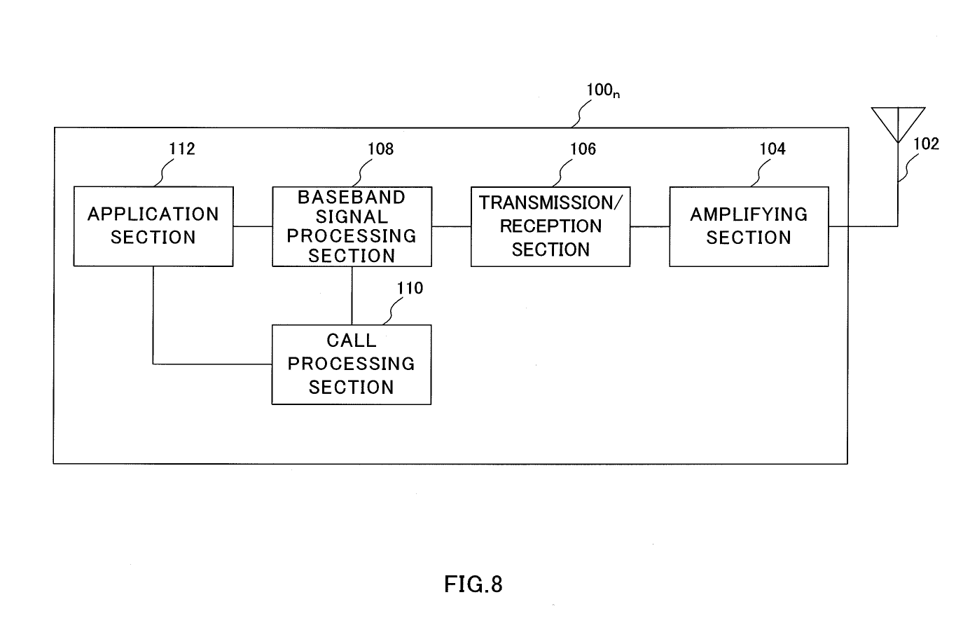

FIG. 8 is a diagram illustrating a schematic configuration of the mobile terminal apparatus according to the Embodiment of the invention. As shown in FIG. 8, the mobile terminal apparatus 100ₙ is provided with a transmission/reception antenna 102, amplifying section 104, transmission/reception section 106, baseband signal processing section 108, call processing section 110 and application section 112. In receiving signals, a radio frequency signal received in the transmission/reception antenna 102 is amplified in the amplifying section 104, subjected to frequency conversion in the transmission/reception section 106, and is converted into a baseband signal. The baseband signal is subjected to FFT processing, error correcting decoding, reception processing of retransmission control, etc. in the baseband signal processing section 108. Among the data in downlink, user data in downlink is transferred to the application section 112. The application section 112 performs processing concerning layers higher than the physical layer and MAC (Medium Access Control) layer and the like. Further, among the data in downlink, broadcast information is also transferred to the application section 112.

Meanwhile, in transmitting signals, the application section 112 inputs user data in uplink into the baseband signal processing section 108. The baseband signal processing section 108 performs transmission processing of retransmission control (Hybrid ARQ) , channel coding, Discrete Fourier Transform (DFT), Inverse Fast Fourier Transform (IFFT), etc. on the data to transfer to the transmission/reception section 106. The transmission/reception section 106 performs frequency conversion processing for converting the baseband signal output from the baseband signal processing section 108 into a signal with a radio frequency band, and then, the signal is amplified in the amplifying section 104, and is transmitted from the transmission/reception antenna 102. In addition, the call processing section 110 performs management of communications with the radio base station apparatus 200, etc.

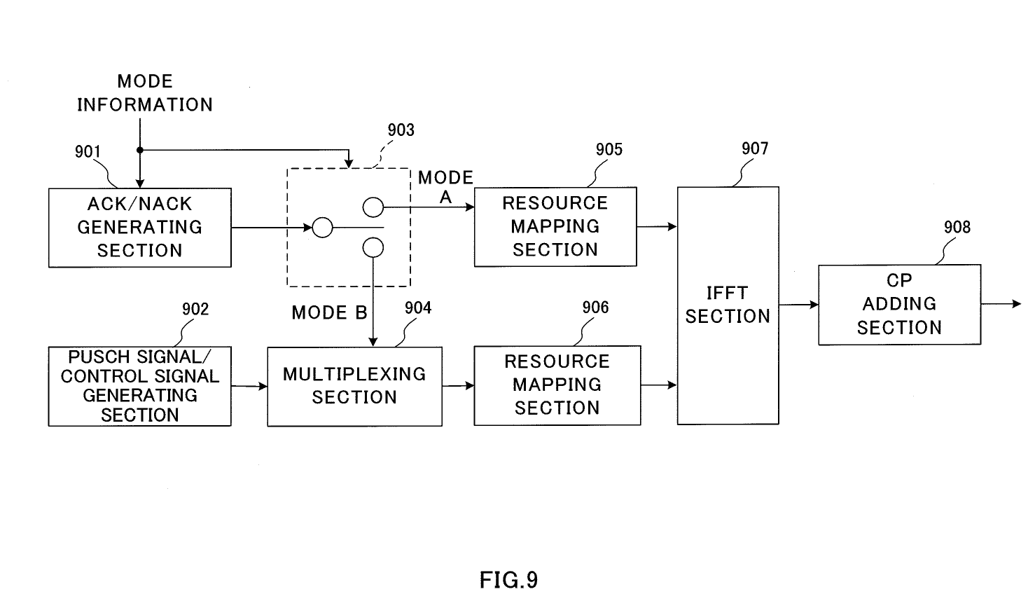

FIG. 9 is a functional block diagram of the baseband signal processing section of the mobile terminal apparatus as shown in FIG. 8. In FIG. 9, to simplify the explanation, only the transmission section side is described. As shown in FIG. 9, the baseband signal processing section is provided with an ACK/NACK generating section 901, PUSCH signal/control signal generating section 902, switching section 903, multiplexing section 904, resource mapping sections 905, 906, IFFT section 907, and CP (Cyclic Prefix) adding section 908.

The ACK/NACK generating section 901 determines an error of the PUSCH signal, and as a result, generates ACK/NACK that is a retransmission response signal. The ACK/NACK generating section 901 generates ACK/NACK according to a transmission method (mode) of the retransmission response signal. In other words, the ACK/NACK generating section 901 generates ACK/NACK that is a retransmission response signal for each of a plurality of downlink CCs in the first transmission method (mode A), and generates ACK that is a single retransmission response signal for a plurality of downlink CCs in the second transmission method (mode B) (generates single ACK when retransmission response signals for all the downlink CCs are ACK.) The ACK/NACK generating section 901 outputs the generated ACK/NACK to the resource mapping section 905 or multiplexing section 904 via the switching section 903. In addition, the mode information concerning the transmission method of the retransmission response signal is notified to the ACK/NACK generating section 901 by Higher layer signaling or PDCCH.

The PUSCH signal/control signal generating section 902 generates a PUSCH signal (user data) that is another signal except the retransmission response signal, and a signal of control information (control signal) except the retransmission response signal. The PUSCH signal/control signal generating section 902 outputs the PUSCH signal and control signal to the multiplexing section 904.

Based on the mode information concerning the transmission method of the retransmission response signal, the switching section 903 switches an output destination of the retransmission response signal to the resource mapping section 905 or the multiplexing section 904. In other words, the switching section 903 switches the output destination so as to output the retransmission response signal to the resource mapping section 905 in the first transmission method (mode A), while outputting the retransmission response signal to the multiplexing section 904 in the second transmission method (mode B). Accordingly, in the case of mode A, the retransmission response signal is output to the resource mapping section 905, while in the case of mode B, being output to the multiplexing section 904. In addition, the mode information concerning the transmission method of the retransmission response signal is notified to the switching section 903 by Higher layer signaling or PDCCH.

The multiplexing section 904 multiplexes the retransmission response signal and another signal in the second transmission method (mode B). In other words, in the case of mode B, the multiplexing section 904 multiplexes the retransmission response signal (ACK) and the PUSCH signal/control signal. The multiplexing section 904 outputs the multiplexed signal to the resource mapping section 906.

The resource mapping sections 905, 906 map the retransmission response signal and another signal to different resources in the mode A, while mapping the retransmission response signal and another signal to the same resources in the mode B.

In the case of mode A, the resource mapping section 905 performs resource-mapping of the retransmission response signal, while the resource mapping section 906 performs resource-mapping of the PUSCH signal/control signal. For example, in the case of mode A, in multiplexing by FDM, as shown in FIG. 5(a), the resource mapping section 905 maps the retransmission response signal to the PUCCH, and maps the PUSCH signal/control signal to the PUSCH. In the case of mode A, in multiplexing by CDM, as shown in FIG. 5(b), the resource mapping section 905 code-multiplexes retransmission response signals for a plurality of downlink CCs into the PUSCH. Further, the resource mapping section 905 maps the retransmission response signal to the PUSCH, the resource mapping section 906 maps the PUSCH signal and control signal to the PUSCH, and the retransmission response signal, and the PUSCH signal and/or control signal are code-multiplexed. In this case, the code used for the retransmission response signal is set by a resource index of the downlink scheduling information, and is multiplied by the retransmission response signal in the ACK/NACK signal generating section 901. The codes used in the PUSCH signal and control signal are notified using predetermined code numbers by Higher layer signaling, and are multiplied by the PUSCH signal and control signal in the PUSCH signal/control signal generating section 902.

In the case of mode B, the resource mapping section 906 performs resource-mapping of the retransmission response signal, while performing resource-mapping of the PUSCH signal/control signal. For example, in the case of mode B, as shown in FIG. 6, the resource mapping section 906 maps the PUSCH signal/control signal to the PUSCH, and maps the retransmission response signal to the same resources of the PUSCH.

The IFFT section 907 performs IFFT on the resource-mapped signal to transform into the signal in the time domain. The IFFT section 907 outputs the IFFT-processed signal to the CP adding section 908. The CP adding section 908 adds a CP to the IFFT-processed signal. The CP-added signal is transmitted to the radio base station apparatus in uplink via the antenna.

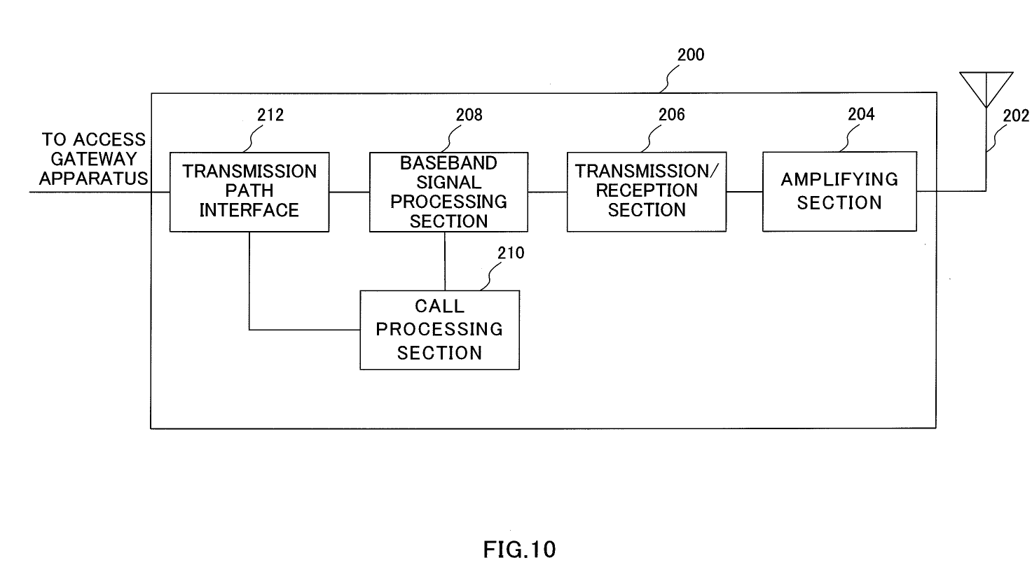

FIG. 10 is a diagram illustrating a schematic configuration of the radio base station apparatus according to the Embodiment of the invention. As shown in FIG. 10, the radio base station apparatus 200ₙ is provided with a transmission/reception antenna 202, amplifying section 204, transmission/reception section 206, baseband signal processing section 208, call processing section 210 and transmission path interface 212. In receiving signals, a radio frequency signal received in the transmission/reception antenna 202 is amplified in the amplifying section 204, subjected to frequency conversion in the transmission/reception section 206, thereby converted into a baseband signal, and is input into the baseband signal processing section 208. The baseband signal processing section 208 performs FFT processing, IDFT processing, error correcting decoding, reception processing of MAC retransmission control, and reception processing of RLC layer and PDCP layer on the user data included in the input baseband signal, and transfers the resultant to the access gateway apparatus via the transmission path interface 212. The call processing section 210 performs call processing such as setting and release of the communication channel, status management of the radio base station 200, and management of radio resources.

Meanwhile, in transmission, the user data transmitted in downlink is input to the baseband signal processing section 208 via the transmission path interface 212 from the access gateway apparatus 300 that is an upper station of the radio base station apparatus 200ₙ. The baseband signal processing section 208 performs PDCP layer processing for assigning sequence numbers, etc., segmentation and concatenation of user data, RLC (Radio Link Control) layer transmission processing such as transmission processing of RLC retransmission control, MAC retransmission control e.g. HARQ transmission processing, scheduling, transmission format selection, channel coding, IFFT processing and precoding processing, and transfers the processed signal to the transmission/reception section 206. Further, with respect to signals of the Physical Downlink Control Channel that is a downlink control channel, the transmission processing such as channel coding and Inverse Fast Fourier Transform is performed, and the resultant is transferred to the transmission/reception section 206. Further, the baseband signal processing section 208 notifies the mobile terminal apparatus 100, of control information for communications in the cell 50, on the broadcast channel. For example, the broadcast information for communications in the cell 50ₙ includes the system bandwidth in uplink or downlink, identification information of a root sequence (Root Sequence Index) to generate a signal of a random access preamble on the PRACH (Physical Random Access Channel), etc. The transmission/reception section 206 performs frequency conversion processing for converting the baseband signal output from the baseband signal processing section 208 into a signal with a radio frequency band, and then, the signal subjected to the frequency conversion processing is amplified in the amplifying section 204 and transmitted from the transmission/reception antenna 202.

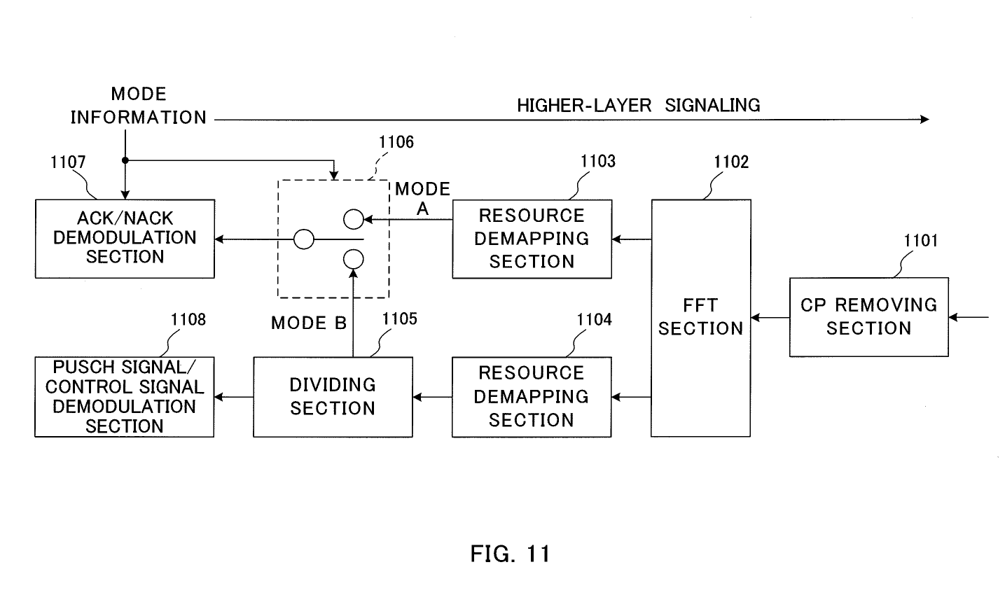

FIG. 11 is a functional block diagram of the baseband signal processing section of the radio base station apparatus as shown in FIG. 10. In FIG. 11, to simplify the explanation, only the reception section side is described. As shown in FIG. 11, the baseband signal processing section is provided with a CP removing section 1101, Fast Fourier Transform section 1102, resource demapping sections 1103, 1104, dividing section 1105, switching section 1106, ACK/NACK demodulation section 1107, and PUSCH signal/control signal demodulation section 1108.

The CP removing section 1101 removes the CP from the signal including the uplink retransmission response signal and another signal received via the antenna. The CP removing section 1101 outputs the CP-removed signal to the FFT section 1102. The FFT section 1102 performs FFT on the CP-removed signal to transform into the signal in the frequency domain. The FFT section 102 outputs the FFT-processed signal to the resource demapping sections 1103, 1104.

The resource demapping sections 1103, 1104 perform resource-demapping of the retransmission response signal and another signal mapped to different resources in the mode A, while performing resource-demapping of the retransmission response signal and another signal mapped to the same resources in the mode B, respectively.

In the case of mode A, the resource demapping section 1103 performs resource-demapping of the retransmission response signal, while the resource demapping section 1104 performs resource-demapping of the PUSCH signal/control signal. In the case of mode B, the resource demapping section 1104 performs resource-demapping of the retransmission response signal, while performing resource-demapping of the PUSCH signal/control signal.

The dividing section 1105 divides the retransmission response signal and another signal in the second transmission method (mode B). In other words, in the case of mode B, the dividing section 1105 divides the retransmission response signal (ACK) and PUSCH signal/control signal. The dividing section 1105 outputs the PUSCH signal and control signal in the divided signals to the PUSCH signal/control signal demodulation section 1108 and ACK/NACK demodulation section 1107.

Based on the mode information concerning the transmission method of the retransmission response signal, the switching section 1106 switches an input source to the demodulation section to the resource demapping section 1103 or the dividing section 1105. In other words, in the first transmission method (mode A), the switching section 1106 switches to output the retransmission response signal from the resource demapping section 1103 to the ACK/NACK demodulation section 1107, while outputting the PUSCH signal/control signal from the resource demapping section 1104 to the PUSCH signal/control signal demodulation section 1108, and in the second transmission method (mode B), switches to output the retransmission response signal from the dividing section 1105 to the ACK/NACK demodulation section 1107, while outputting the PUSCH signal/control signal from the dividing section 1105 to the PUSCH signal/control signal demodulation section 1108. In addition, the mode information concerning the transmission method of the retransmission response signal is notified to the switching section 1106. Further, the mode information is notified to the mobile terminal apparatus by Higher layer signaling and PDCCH.

The ACK/NACK demodulation section 1107 demodulates ACK/NACK that is the retransmission response signal. According to the transmission method (mode) of the retransmission response signal, the ACK/NACK demodulation section 1107 demodulates ACK/NACK. In other words, the ACK/NACK demodulation section 1107 demodulates ACK/NACK that is a retransmission response signal for each of a plurality of downlink CCs in the first transmission method (mode A), and demodulates ACK that is a single retransmission response signal for a plurality of downlink CCs in the second transmission method (mode B) (demodulates single ACK when retransmission response signals to all the downlink CCs are ACK.) In addition, the mode information concerning the transmission method of the retransmission response signal is notified to the ACK/NACK demodulation section 1107. The PUSCH signal/control signal demodulation section 108 demodulates the PUSCH signal and signal (control signal) of control information.

Described next is a radio communication method in the mobile terminal apparatus and radio base station apparatus having the above-mentioned configurations.

First, the mobile terminal apparatus receives a PDSCH signal, and determines an error of the PDSCH signal. Then, according to a result of the error determination, the ACK/NACK generating section 901 generates the retransmission response signal (ACK/NACK). In the mode A, retransmission response signals to a plurality of downlink CCs are parallel transmitted with different resources. Therefore, the switching section 903 is switched, and the output destination of the retransmission response signal is the resource mapping section 905, while the output destination of the PUSCH signal/control signal is the resource mapping section 906.

For example, in the case of mode A, in multiplexing by FDM, as shown in FIG. 5(a), the resource mapping section 905 maps the retransmission response signal to the PUCCH, and maps the PUSCH signal/control signal to the PUSCH. In the case of mode A, in multiplexing by CDM, as shown in FIG. 5(b), the resource mapping section 905 code-multiplexes retransmission response signals to a plurality of downlink CCs into the PUCCH. Further, the resource mapping section 905 maps the retransmission response signal to the PUSCH, the resource mapping section 906 maps the PUSCH signal and control signal to the PUSCH, and the retransmission response signal, and PUSCH signal and/or control signal are code-multiplexed.

In the case of mode B, as shown in FIG. 6, the resource mapping section 906 maps the PUSCH signal/control signal to the PUSCH, and maps the retransmission response signal to the same resources of the PUSCH.

The signals thus subjected to resource mapping in the resource mapping sections 905, 906 are subjected to IFFT in the IFFT section 907, and transformed into the signal in the time domain, and the signal is given the CP in the CP adding section 908, and is transmitted to the radio base station apparatus as an uplink signal.

The radio base station apparatus receives the uplink signal including the retransmission response signal and PUSCH signal/control signal. In the radio base station apparatus, the CP removing section 1101 removes the CP from the uplink signal, and the CP-removed signal is subjected to FFT in the FFT section 1102 to be the signal in the frequency domain. Next, the signal in the frequency domain is subjected to resource demapping in the resource demapping sections 1103, 1104. In other words, in the mode A, the resource demapping sections 1103, 1104 perform resource-demapping respectively on the retransmission response signal and PUSCH signal/control signal mapped to different resources. Meanwhile, in the mode B, the retransmission response signal and PUSCH signal/control signal mapped to the same resources are resource-demapped.

At this point, based on the mode information, the switching section 1106 switches the input source to the demodulation section to the resource demapping section 1103 or the dividing section 1105. In other words, in the mode A, the switching section 1106 switches to output the retransmission response signal from the resource demapping section 1103 to the ACK/NACK demodulation section 1107, while outputting the PUSCH signal/control signal from the resource demapping section 1104 to the PUSCH signal/control signal demodulation section 1108, and in the mode B, switches to output the retransmission response signal from the dividing section 1105 to the ACK/NACK demodulation section 1107, while outputting the PUSCH signal/control signal from the dividing section 1105 to the PUSCH signal/control signal demodulation section 1108.

In the mode B, the dividing section 1105 divides the retransmission response signal and PUSCH signal/control signal, Among the divided signals, the PUSCH signal and control signal are demodulated in the PUSCH signal/control signal demodulation section 1108, and the retransmission response signal is demodulated in the ACK/NACK demodulation section 1107.

Thus, in the invention, according to a transmission form (first mode, second mode) of a retransmission response signal, the retransmission response signal and another signal are mapped to different resources, or the retransmission response signal and another signal are mapped to the same resources (the multiplexing method is switched corresponding to the mode), and it is thereby possible to efficiently transmit data signals and control information for a plurality of component carriers.

The invention is not limited to the aforementioned Embodiment, and is capable of being carried into practice with various modifications thereof. The above-mentioned Embodiment describes the case where two resource mapping sections and two resource demapping sections are provided, but the invention is not limited thereto, and a single resource mapping section and a single resource demapping section may be adopted as long as the functions of the invention are exerted. Further, without departing from the scope of the invention, the number of processing sections and processing procedures in the above-mentioned description are capable of being carried into practice with modifications thereof as appropriate. Furthermore, each element shown in the figures represents the function, and each function block may be actualized by hardware or may be actualized by software. Moreover, the invention is capable of being carried into practice with modifications thereof as appropriate without departing from the scope of the invention.

### INDUSTRIAL APPLICABILITY

The invention is useful in the mobile terminal apparatus, radio base station apparatus and radio communication method in the LTE-A systems.

The present application is based on Japanese Patent Application No. 2009-252367 filed on Nov. 2, 2009, entire content of which is expressly incorporated by reference herein.

1. A mobile terminal apparatus comprising:
a retransmission response signal generating section configured to generate a retransmission response signal; and
a resource mapping section configured to map the retransmission response signal and another signal to different resources in a first mode for transmitting a retransmission response signal for each downlink component carrier of a plurality of downlink component carriers, while mapping the retransmission response signal and another signal to the same resources in a second mode for transmitting a single retransmission response signal for a plurality of downlink component carriers.

2. The mobile terminal apparatus according to claim 1, further comprising:
a multiplexing section configured to multiplex the retransmission response signal and the another signal in the second mode.

3. The mobile terminal apparatus according to claim 2, further comprising:
a switching section configured to switch an output destination of the retransmission response signal to the resource mapping section or the multiplexing section, based on mode information indicative of the first mode or the second mode.

4. The mobile terminal apparatus according to claim 1, wherein the another signal is an uplink shared channel signal or uplink control information.

5. A radio base station apparatus comprising:
a reception section configured to receive an uplink signal including a retransmission response signal and another signal;
a resource demapping section configured to perform resource-demapping of each of the retransmission response signal and the another signal mapped to different resources in a first mode for transmitting a retransmission response signal for each downlink component carrier of a plurality of downlink component carriers, while performing resource-demapping of the retransmission response signal and the another signal mapped to the same resources in a second mode for transmitting a single retransmission response signal for a plurality of downlink component carriers; and a demodulation section configured to demodulate the retransmission response signal.

6. The radio base station apparatus according to claim 5, further comprising:
a dividing section configured to divide the retransmission response signal and the another signal in the second mode.

7. The radio base station apparatus according to claim 6, further comprising:
a switching section configured to switch an input source to the demodulation section to the resource demapping section or the dividing section, based on mode information indicative of the first mode or the second mode.

8. The radio base station apparatus according to claim 5, wherein the another signal is an uplink shared channel signal or uplink control information.

9. A radio communication method comprising:
in a mobile terminal apparatus,
generating a retransmission response signal;
mapping the retransmission response signal and another signal to different resources in a first mode for transmitting a retransmission response signal for each downlink component carrier of a plurality of downlink component carriers, while mapping the retransmission response signal and another signal to the same resources in a second mode for transmitting a single retransmission response signal for a plurality of downlink component carriers;
transmitting an uplink signal including the retransmission response signal and the another signal to a radio base station apparatus;
in the radio base station apparatus,
receiving the uplink signal;
performing resource-demapping of each of the retransmission response signal and the another signal mapped to different resources in the first mode, while performing resource-demapping of the retransmission response signal and the another signal mapped to the same resources in the second mode; and
demodulating the retransmission response signal.

10. The radio communication method according to claim 9, further comprising:
in the mobile terminal apparatus, multiplexing the retransmission response signal and the another signal in the second mode; and
in the radio base station apparatus, dividing the retransmission response signal and the another signal in the second mode.

11. The radio communication method according to claim 9, further comprising:
in the mobile terminal apparatus, switching an output destination of the retransmission response signal based on mode information indicative of the first mode or the second mode; and
in the radio base station apparatus, switching an input source to a demodulation section based on the mode information.

12. The radio communication method according to claim 9, wherein the another signal is an uplink shared channel signal or uplink control information.
